(19) United States
(12) Patent Application Publication
(10) Pub. No.: US 2016/0312389 A1
(43) Pub. Date: Oct. 27, 2016

(54) Adhesive Fabric Woven By Circular Knitting And Method For Forming Three-Dimensional Patterns Using The Same

(71) Applicants: Ji Sang Jang, Busan (KR); Jae Jung Lee, Busan (KR); Kyung Suk Choi, Busan (KR)

(72) Inventors: Ji Sang Jang, Busan (KR); Jae Jung Lee, Busan (KR); Kyung Suk Choi, Busan (KR)

(21) Appl. No.: 14/696,354

(22) Filed: Apr. 24, 2015

(51) Int. Cl. D04B 1/12; B29C 43/22; B32B 5/26; B29C 67/00; D04B 1/22; B32B 5/02

(52) U.S. Cl. CPC D04B 1/12; D04B 1/22; B32B 5/026; B32B 5/26; B29C 67/0074; B29C 43/222; B32B 2437/02; B33Y 10/00

(57) ABSTRACT

The present invention relates to an adhesive fabric woven by circular knitting and a method for forming a three-dimensional pattern using the same, and more particularly, to such an adhesive fabric woven by circular knitting and a method for forming a three-dimensional pattern using the same, in which a yarn coated with a hotmelt resin and a fabric yarn are woven by circular knitting to manufacture an adhesive fabric formed with an upper layer woven by the fabric yarn and a lower layer woven by the yarn coated with a hotmelt resin, the adhesive fabric is laminated on a base fabric, and the laminated adhesive fabric is subjected to a surface molding process to form a three-dimensional pattern on the adhesive fabric, so that a textile texture but not a plastic texture can be expressed on the adhesive fabric, thereby improving flexibility and air permeability.

### CROSS-REFERENCE TO RELATED APPLICATIONS

This application claims the benefit of Korean Patent Application No. 10-2014-0051799, filed on Apr. 29, 2014 in the Korean Intellectual Property Office, which is incorporated herein by reference in its entirety.

### BACKGROUND OF THE INVENTION

1. Field of the Invention

The present invention relates to an adhesive fabric woven by circular knitting and a method for forming a three-dimensional pattern using the same, in which a yarn coated with a hotmelt resin and a fabric yarn are woven by circular knitting to manufacture an adhesive fabric formed with an upper layer woven by the fabric yarn and a lower layer (i.e., a bonding surface bonded to a base fabric) woven by the yarn coated with a hotmelt resin, the adhesive fabric is laminated on a base fabric, and the laminated adhesive fabric is subjected to a surface molding process to form a three-dimensional pattern on the adhesive fabric.

2. Description of Related Art

In general, a screen printing method is typically used to in order to form patterns on various kinds of fabrics. Various designs including letters, figures, pictures or real photos are implemented by the screen printing method, but are not limited to two-dimensional representations.

Thus, in recent years, technologies for stereoscopically representing various kinds of designs on the surface of a fabric have been developed. The technologies mainly adopt a pop screen printing method of stereoscopically representing patterns through foaming, a laminating method of stereoscopically representing patterns by injecting and laminating the patterns using a 3D scanner or an injecting robot, or a PU casting method of stereoscopically representing patterns by charging a liquid polyurethane (PU) into a mold.

More specifically, in case of the pop screen printing method, a foam resin is coated on a fabric and is dried by hot air or dried naturally at room temperature, and then heat is applied to the fixed foam resin to foam the resin to thereby form a stereoscopic pattern as disclosed in patent document 1.

However, the patent document 1 entails a problem in that the process is very complicated as well as the process time is very long.

The patent document 1 encounters a problem in that because a worker performs an operation of manually coating the foam on the fabric, a difference in the design representation occurs depending on the degree of the skillfulness of the worker, thus leading to a difference in the quality of the finished fabric. In addition, there occurs a problem in that when the resin is not completely foamed, a desired stereoscopic texture is fully represented.

Besides, in case of the laminating method, a composition for forming a pattern is injected onto and laminated on the surface of a fabric from a nozzle using a device including an ignition mechanism, and the laminated composition is cured to thereby form a three-dimensionally represented part as disclosed in patent document 2.

However, the patent document 2 entails a problem in that the injection and lamination time is long as well as the curing time of the stereoscopically represented pattern is very long, thus leading to an increase in the entire process time.

In addition, in case of the PPU casting method, a base sheet and a resin are charged into a mold having a shape corresponding to that of a desired pattern, and then the resin is removed from the mold and cured to thereby form a stereoscopic pattern as disclosed in patent document 3.

However, the patent document 3 also entails a problem in that the curing time of the stereoscopically represented pattern is very long, thus leading to an increase in the entire process time.

In an effort to solve the above problems, the present applicant of the present invention has filed an application of an invention entitled “Method of Forming Three-Dimensional Pattern using Adhesive Fabric” such as patent document 4 (non-published, granted a patent on Apr. 24, 2014).

More specifically, the patent document 4 discloses that either a yarn coated with a hotmelt resin or a yarn coated with a hotmelt resin and a TPU(thermoplastic polyurethane) yarn is/are woven in the shape of a mesh fabric having through-holes in a tricot weaving fashion to manufacture an adhesive fabric, the adhesive fabric is laminated on a base fabric, and the laminated adhesive fabric is formed with a protruded part and a compressed part through a simple surface molding process to thereby implement a stereoscopic pattern, thus leading to a significant reduction in the number of the process and the process time.

However, the patent document 4 also entails a problem in that either the hotmelt resin or the yarn coated with a hotmelt resin and the TPU yarn is/are woven, so that a plastic texture but not a textile texture is expressed, thus leading to a reduction in flexibility.

### PRIOR ART LITERATURE

### Patent Documents

Document 1: Korean Patent Registration No. 10-0278061 entitled “Woven Fabric Goods having Three-Dimensional Decorative Pattern and Method of Forming The Three-Dimensional Decorative Pattern”

Document 2: Korean Patent Registration No. 10-0264026 entitled “Method of Forming Three-Dimensional Pattern”

Document 3: Korean Patent Laid-out Publication No. 10-2007-0044750 entitled “Customized Insole by Combination of Multi-Materials and Manufacturing Method Thereof”

Document 4: Korean Patent Application No. 10-2014-0018844 “Method of Forming Three-Dimensional Pattern using Adhesive Fabric”

### SUMMARY OF THE INVENTION

Accordingly, the present invention has been made by an improvement of the above patent document 4, of which application had been previously filed by the applicant and was granted a patent, to solve the aforementioned problems occurring in the prior art, and it is an object of the present invention to provide an adhesive fabric woven by circular knitting, in which a yarn coated with a hotmelt resin and a fabric yarn are woven by circular knitting to manufacture the adhesive fabric formed with an upper layer woven by the fabric yarn and a lower layer (i.e., a bonding surface bonded to a base fabric) woven by the yarn coated with a hotmelt resin.

Another object of the present invention is to provide a method for forming a three-dimensional pattern using an adhesive fabric woven by circular knitting, in which the adhesive fabric can be bonded to a base fabric by the lower layer (i.e., a layer woven by a yarn coated with a hotmelt resin) even without a separate adhesive during the surface molding process, and a textile texture but not a plastic texture can be expressed by the upper layer (i.e., a layer woven by a fabric yarn), thereby improving flexibility and air permeability.

Still another object of the present invention is to provide a method for forming a three-dimensional pattern using an adhesive fabric woven by circular knitting, in which the adhesive fabric is laminated on a base fabric, and then the laminated adhesive fabric is formed with a protruded part and a compressed part through a simple surface molding process of forming a three-dimensional pattern to thereby implement a stereoscopic pattern, thus leading to a significant reduction in the number of the process and the process time, and improving abrasion resistance against the compressed part.

Herein, the reason why the yarn of the adhesive fabric woven by circular knitting is limited to the yarn coated with a hotmelt resin and the fabric yarn is that if either only the yarn coated with a hotmelt resin or the yarn coated with a hotmelt resin and the TPU yarn is/are woven by circular knitting, a plastic texture but not a textile texture is expressed, thus leading to a reduction in flexibility as well as the yarn is molten and compressed during the surface molding, and thus the through-holes of the adhesive fabric are blocked, thereby degrading air permeability.

To achieve the above objects, in another aspect, the present invention provides an adhesive fabric woven by circular knitting, in which a yarn 21 coated with a hotmelt resin and a fabric yarn 22 are woven by circular knitting to produce the adhesive fabric.

In this case, preferably, the adhesive fabric 20 woven by circular knitting may include an upper layer L1 woven by the fabric yarn 22 and a lower layer L2 woven by the yarn 21 coated with a hotmelt resin.

In addition, the yarn 21 coated with a hotmelt resin

Meanwhile, the yarn 21 coated with a hotmelt resin may be formed such that a hotmelt resin 21d is coated on the outer surface of a fabric yarn 21c consisting of a core 21a and a sheath 21b in an amount of 0.05-0.3 g/m, any of a polyester yarn, a nylon yarn, and a cotton yarn may be used alone or a combination of two or more kinds of them may be used as the fabric yarn 21c, and any of a polyester resin, a polyurethane resin, an acrylic resin, a polyimide resin, an ethylene vinyl acetate resin, and a polyolefin resin may be used alone or a combination of two or more kinds of them may be used as the hotmelt resin 21d.

In another aspect, the present invention provides a method for forming a three-dimensional pattern using an adhesive fabric woven by circular knitting, the method including:

a step (S100) of laminating the adhesive fabric 20 woven by circular knitting on the top surface of a base fabric 10; and

a step (S200) of subjecting the laminated adhesive fabric 20 to a surface molding process to form the three-dimensional pattern.

In this case, in step S100, the adhesive fabric 20 woven by circular knitting may be preferably laminated on the base fabric 10 such that a lower layer L2 woven by a yarn 21 coated with a hotmelt resin in the adhesive fabric 20 is bonded to the base fabric 10.

In addition, in step S200, the surface of the adhesive fabric 20 woven by circular knitting may be preferably compressed at a temperature of 100-150° C. and a pressure of 10˜50 kg/cm² for 10-30 seconds using a mold 30 having an engraved part 30a formed thereon so that the adhesive fabric 20 has a protruded part 20a formed on a region thereof, which corresponds to the engraved part 30a of the mold 30 and a compressed part 20b formed on the remaining region thereof other than the protruded part 20a to thereby form the three-dimensional pattern.

According to the present invention, the yarn coated with a hotmelt resin and the fabric yarn are woven by circular knitting to manufacture the adhesive fabric formed with the upper layer woven by the fabric yarn and the lower layer (i.e., a bonding surface bonded to the base fabric) woven by the yarn coated with a hotmelt resin, so that the adhesive fabric can be bonded to the base fabric by the lower layer (i.e., a layer woven by the yarn coated with a hotmelt resin) even without a separate adhesive during the surface molding process, and a textile texture but not a plastic texture can be expressed by the upper layer (i.e., a layer woven by the fabric yarn), thereby improving flexibility and air permeability.

Further, the adhesive fabric is laminated on a base fabric, and then the laminated adhesive fabric is formed with the protruded part and the compressed part through a simple surface molding process of forming a three-dimensional pattern to thereby implement a stereoscopic pattern, thus leading to a significant reduction in the number of the process and the process time, and improving abrasion resistance against the compressed part during the surface molding (for example, 40 cycle before molding and the compressed part having 2,500 cycle after molding).

In the meantime, various colors of the base fabric are transmitted to and represented on the surface of the adhesive fabric woven by circular knitting during the surface molding so that various designs and colors can be implemented, thereby resulting in an increase in the value of the product.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The above and other objects, features and advantages of the present invention will be apparent from the following detailed description of the preferred embodiments of the invention when taken in conjunction with the accompanying drawings, in which:

FIG. 1 illustrates real photos of the woven structure and the vertical cross section of an adhesive fabric woven by circular knitting according to the present invention

FIG. 2 is a cross-sectional view illustrating a structure of a yarn coated with a hotmelt resin according to the present invention;

FIG. 3 is a flowchart illustrating a method for forming a three-dimensional pattern using an adhesive fabric woven by circular knitting according to the present invention;

FIG. 4 is a real photo illustrating an adhesive fabric woven by circular knitting;

FIG. 5 is a real photo illustrating a mold applied to the present invention; and

FIG. 6 is a real photo illustrating a state in which a three-dimensional pattern is formed according to the present invention.

### EXPLANATION ON SYMBOLS

10: fabric

20: adhesive fabric woven by circular knitting

20a: protruded part

20b: compressed part

21: yarn coated with a hotmelt resin

21a: core

21b: sheath

22, 21c: fabric yarn

21d: hotmelt resin

30: mold

30a: engraved part

L1: upper layer

L2: lower layer

### DETAILED DESCRIPTION OF THE PREFERRED EMBODIMENTS

The present invention for achieving the above-mentioned effects is directed to a shoe midsole coated with an adhesive fabric. In the meantime, in the detailed description and the accompanying drawings, illustration and explanation on the construction and operation which a person skilled in the art can easily understand will be briefly made or will be omitted to avoid redundancy. In particular, illustration and explanation on the detailed technical construction and operation of elements, which have no direct connection with the technical features of the present invention, will be omitted, and only the technical constructions directly related with the present invention will be briefly illustrated and explained.

Hereinafter, an adhesive fabric woven by circular knitting and a method for forming a three-dimensional pattern using the same according to the present invention will be described in detail with reference to the accompanying drawings.

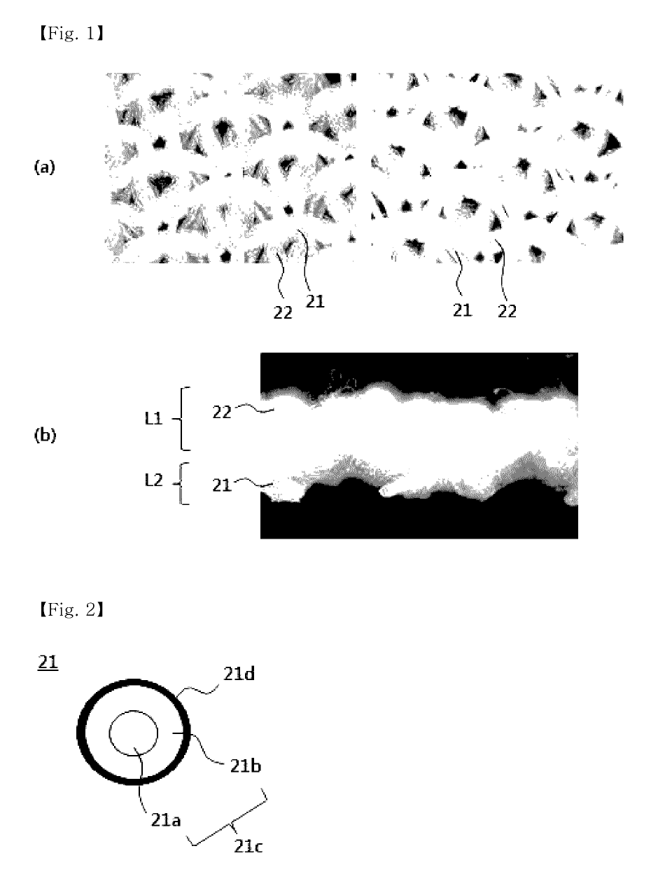

First, an adhesive fabric 20 woven by circular knitting according to the present invention is configured such that a yarn 21 coated with a hotmelt resin and a fabric yarn 22 are woven by circular knitting to produce the adhesive fabric as shown in FIG. 1(a). The adhesive fabric 20 woven by circular knitting includes an upper layer L1 woven by the fabric yarn 22 and a lower layer L2 woven by the yarn 21 coated with a hotmelt resin as shown in FIG. 1(b).

As used herein, the term “circular knitting” refers to a form of knitting in which a yarn is organized into annular layers by knitting needles to manufacture a knitted fabric in a weft knitting manner so that multiple plies (i.e., multiple layers) are formed in a single fabric, which is already known in the art.

In other words, because the weaving form, the method and device for weaving a fabric by circular knitting, which are already known in various manners in the art, vary greatly depending on the use purpose, the design and the like of a relevant fabric, they are not particularly limited. Although all of the weaving form, the method and device which are known in the art can be applied to the present invention, the adhesive fabric 20 is woven such that the upper layer L thereof is woven by the fabric yarn 22 and the lower layer L2 thereof is woven by the yarn 21 coated with a hotmelt resin as shown in FIG. 1(b) in an embodiment of in the present invention.

In the meantime, as shown in FIG. 2, a hotmelt resin 21d is coated on the outer surface of a fabric yarn 21c consisting of a core 21a and a sheath 21b in an amount of 0.05-0.3 g/m. If the coating amount of the hotmelt resin 21d is less than 0.05 g/m, the three-dimensional pattern will not be formed smoothly. On the contrary, if the coating amount of the hotmelt resin 21d exceeds 0.3 g/m, a defect will occur when the adhesive fabric 20 is woven by circular knitting due to a large amount of the hotmelt resin 21d.

In this case, any of a polyester yarn, a nylon yarn, and a cotton yarn may be used alone or a combination of two or more kinds of them may be used as the fabric yarn 21c included in the yarn 21 coated with a hotmelt resin, and any of a polyester resin, a polyurethane resin, an acrylic resin, a polyimide resin, an ethylene vinyl acetate resin, and a polyolefin resin may be used alone or a combination of two or more kinds of them may be used as the hotmelt resin 21d.

Herein, the hotmelt resin 21d can be coated on the fabric yarn 21c irrespective of the kind of the fabric yarn 21c. However, if the fabric yarn 21c is the polyester yarn, the polyester resin or the polyurethane resin is preferably coated thereon in view of a fusion property between the fabric yarn 21c and the hotmelt resin 21d through the coating. If the fabric yarn 21c is the nylon yarn, the acrylic resin or the polyimide resin is preferably coated thereon. If the fabric yarn 61c is the cotton yarn, the ethylene vinyl acetate resin or the polyolefin resin is preferably coated thereon.

In addition, any of a polyester yarn, a nylon yarn, and a cotton yarn may be used alone or a combination of two or more kinds of them may be used as a fabric yarn 22 woven together with the yarn 21 coated with a hotmelt resin by circular knitting.

Herein, the reason why the yarn of the adhesive fabric woven by circular knitting is limited to the yarn coated with a hotmelt resin and the fabric yarn is that if either only the yarn coated with a hotmelt resin or the yarn coated with a hotmelt resin and the TPU yarn is/are woven by circular knitting, a plastic texture but not a textile texture is expressed, thus leading to a reduction in flexibility as well as the yarn is molten and compressed during the surface molding, and thus the through-holes of the adhesive fabric are blocked, thereby degrading air permeability.

Meanwhile, the base fabric 10 can employ various fabrics fit for the use purpose of a relevant fabric.

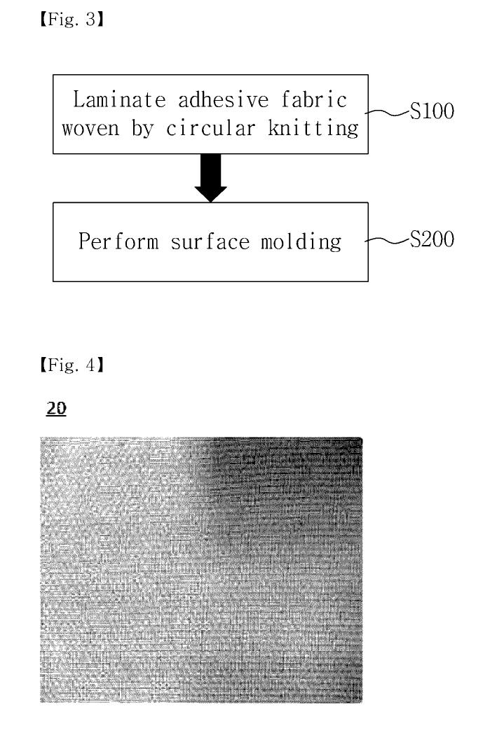

Next, a method for forming a three-dimensional pattern using an adhesive fabric woven by circular knitting includes a step (S100) of laminating the adhesive fabric woven by circular knitting, and a step (S200) of performing a surface molding process as shown in FIG. 3.

The step S100 is a step in which the adhesive fabric 20 woven by circular knitting is laminated on the top surface of a base fabric 10 as shown in FIG. 4 in such a manner that the lower layer L2 woven by the yarn 21 coated with a hotmelt resin in the adhesive fabric 20 is bonded to the base fabric 10.

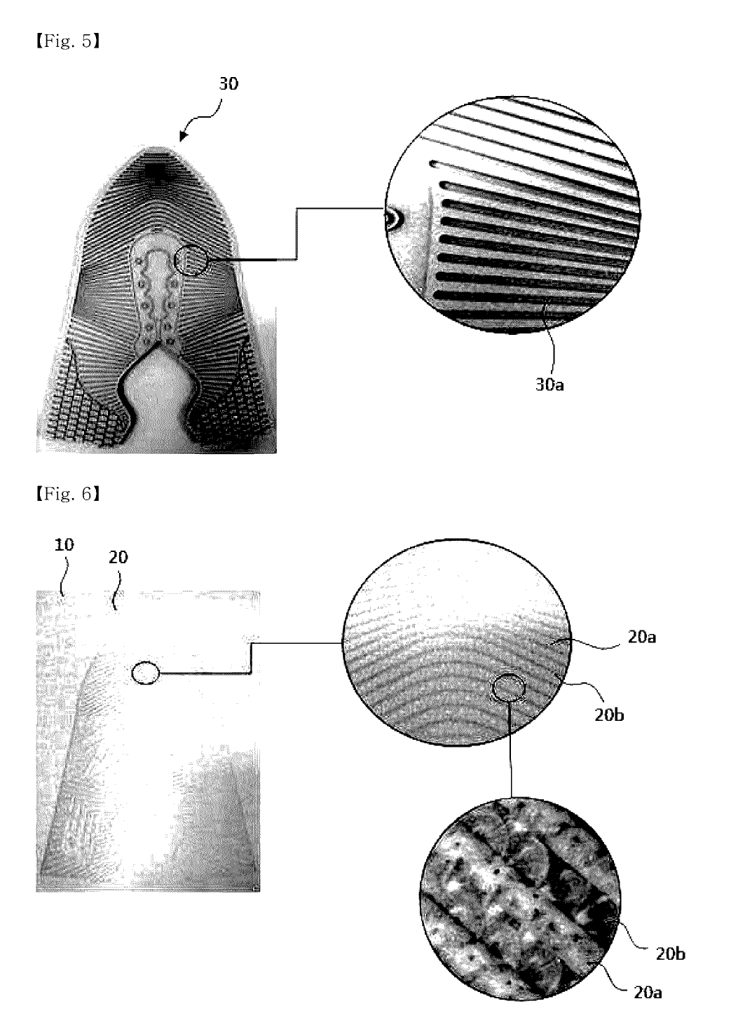

The step S200 is a step in which the laminated adhesive fabric 20 to a surface molding process to form the three-dimensional pattern. In step S200, the surface of the adhesive fabric 20 woven by circular knitting is compressed at a temperature of 100-150° C. and a pressure of 10-50 kg/cm² for 10-30 seconds using a mold 30 having an engraved part 30a formed thereon (In this case, the shapes of the mold and the engraved part can be modified in various manners depending on the design and the shapes shown in FIG. 5 are merely one illustrative embodiment, and the present invention is not limited to this embodiment) as shown in FIG. 5 so that a protruded part 20a is formed on a region of the adhesive fabric 20, which corresponds to the engraved part 30a of the mold 30 and a compressed part 20b is formed on the remaining region (i.e., a region where the engraved part 30a is not formed on the mold 30) of the adhesive fabric 20, other than the protruded part 20a by compressing and melting the remaining region to thereby form the three-dimensional pattern as shown in FIG. 6.

In the meantime, if the surface molding condition is beyond the above range, the three-dimensional pattern will not be formed smoothly.

Thus, According to the present invention, the yarn 21 coated with a hotmelt resin and the fabric yarn 22 are woven by circular knitting to manufacture the adhesive fabric 20 formed with the upper layer L1 woven by the fabric yarn 22 and the lower layer L2 (i.e., a bonding surface bonded to the base fabric 10) woven by the yarn 21 coated with a hotmelt resin, so that the adhesive fabric 20 can be bonded to a base fabric 10 by the lower layer L2 (i.e., a layer woven by the yarn coated with a hotmelt resin) even without a separate adhesive during the surface molding process, and a textile texture but not a plastic texture can be expressed by the upper layer L1 (i.e., a layer woven by the fabric yarn 22), thereby improving flexibility and air permeability. Further, the adhesive fabric 20 is laminated on the base fabric 10, and then the laminated adhesive fabric is formed with the protruded part 20a and the compressed part 20b through a simple surface molding process of forming a three-dimensional pattern to thereby implement a stereoscopic pattern, thus leading to a significant reduction in the number of the process and the process time, and improving abrasion resistance against the compressed part during the surface molding.

As described above, while the shoe midsole coated with an adhesive fabric according to the present invention has been described and illustrated in connection with specific exemplary embodiments with reference to the accompanying drawings, it will be readily appreciated by those skilled in the art that various modifications and changes can be made to the present invention within the technical spirit and scope of the present invention defined in the claims.

What is claimed is:

1. An adhesive fabric woven by circular knitting, in which a yarn 21 coated with a hotmelt resin and a fabric yarn 22 are woven by circular knitting to produce the adhesive fabric.

2. The adhesive fabric woven by circular knitting according to claim 1, wherein the adhesive fabric 20 woven by circular knitting comprises an upper layer L1 woven by the fabric yarn 22 and a lower layer L2 woven by the yarn 21 coated with a hotmelt resin.

3. The adhesive fabric woven by circular knitting according to claim 1, wherein the yarn 21 coated with a hotmelt resin is formed such that a hotmelt resin 21d is coated on the outer surface of a fabric yarn 21c consisting of a core 21a and a sheath 21b in an amount of 0.05-0.3 g/m,
wherein any of a polyester yarn, a nylon yarn, and a cotton yarn is used alone or a combination of two or more kinds of them is used as the fabric yarn 21c, and
wherein any of any of a polyester resin, a polyurethane resin, an acrylic resin, a polyimide resin, an ethylene vinyl acetate resin, and a polyolefin resin is used alone or a combination of two or more kinds of them is used as the hotmelt resin 21d.

4. A method for forming a three-dimensional pattern using the adhesive fabric woven by circular knitting according to any one of claims 1 to 3, the method comprising:
a step (S100) of laminating the adhesive fabric 20 woven by circular knitting on the top surface of a base fabric 10; and
a step (S200) of subjecting the laminated adhesive fabric 20 to a surface molding process to form the three-dimensional pattern.

5. The method according to claim 4, wherein in step S100, the adhesive fabric 20 woven by circular knitting is laminated on the base fabric 10 in such a manner that the lower layer L2 woven by the yarn 21 coated with a hotmelt resin in the adhesive fabric 20 is bonded to the base fabric 10.

6. The method according to claim 4, wherein in step S200, the surface of the adhesive fabric 20 woven by circular knitting is compressed at a temperature of 100-150° C. and a pressure of 10-50 kg/cm² for 10-30 seconds using a mold 30 having an engraved part 30a formed thereon so that the adhesive fabric 20 has a protruded part 20a formed on a region thereof, which corresponds to the engraved part 30a of the mold 30 and a compressed part 20b formed on the remaining region thereof other than the protruded part 20a to thereby form the three-dimensional pattern.
